(19) United States
(12) Patent Application Publication
(10) Pub. No.: US 2014/0279643 A1
(43) Pub. Date: Sep. 18, 2014

(54) System and Method for Probabilistic Prediction of an Applicant's Acceptance

(71) Applicant: American Learning Education Exchange Organization, Washington, DC (US)

(72) Inventor: Dan Ye, Washington, DC (US)

(73) Assignee: American Learning Education Exchange Organization, Washington, DC (US)

(21) Appl. No.: 14/210,648

(22) Filed: Mar. 14, 2014

Related U.S. Application Data
(60) Provisional application No. 61/792,342, filed on Mar. 15, 2013.

(51) Int. Cl. G06Q 50/20; G06Q 10/00

(52) U.S. Cl. CPC G06Q 50/2053; G06Q 10/00
USPC 705/327

(57) ABSTRACT

Various exemplary embodiments disclosed herein relate generally to providing methods executed on a computer and computer-based apparatus, including computer program products, for probabilistic prediction. Specifically, various exemplary embodiments relate to providing probabilistic prediction of an applicant's acceptance by an institution.

### CROSS-REFERENCE TO RELATED APPLICATION

This application claims priority to and the benefit of, and incorporates herein by reference in its entirety, U.S. Provisional Patent Application No. 61/792,342, which was filed on Mar. 15, 2013.

### FIELD OF THE INVENTION

The present invention relates, generally, to systems and methods for probabilistic prediction of an applicant's acceptance.

### BACKGROUND OF THE INVENTION

Applicants can apply to multiple selective institutions for various purposes, such as education (e.g., college admission), real estate (e.g., mortgage application), and/or work placement. For example, many potential students of academic institutions apply to multiple selective academic institutions simultaneously; the rationale for applying to multiple academic institutions includes raising the probability of the applicant's acceptance to at least one such school. However, each institution typically considers different quantitative and/or qualitative metrics and weighs such metrics differently when making a determination about an applicant. Moreover, each institution may not publicly state how such acceptance decisions are determined based on such metrics. As a result, an applicant has little insight into his or her actual chance of acceptance by the institution.

Current admission prediction software is intended to aid applicants in better determining their chances of admission by institutions and accordingly make more informed decisions on which institutions to submit applications. Some existing computerized methods, for example, predict an applicant's probability of acceptance to a specific institution using well-known quantitative metrics. For example, some computerized methods use a prospective student's standardized test scores or grade point average (GPA) to make a prediction. However, such computerized methods heavily rely on the institution's input of “acceptable ranges” with regard to quantitative metrics such as GPA and/or standardized test scores, using only known quantitative measurements when making such predictions.

### SUMMARY OF THE INVENTION

Advantages of the invention include providing predictions of an applicant's admission to an institution, based on both quantitative data and qualitative data.

In one aspect, the invention involves a computerized method for generating a probabilistic prediction of an applicant's acceptance by a selective institution. The method involves collecting, by a computing device, quantitative or qualitative data from the applicant. The method also involves comparing, by the computing device, data from the applicant with statistical quantitative data associated with previous applicants accepted by the institution. The method also involves comparing, by the computing device, data from the applicant with statistical converted qualitative data associated with previous applicants accepted by the institution. The method also involves comparing, by the computing device, data from the applicant with statistical quantitative data associated with previous applicants rejected by the institution. The method also involves comparing, by the computing device, quantitative data from the applicant with statistical converted qualitative data associated with previous applicants rejected by the institution. The method also involves generating, by the computing device, a probability of acceptance based on the comparisons. The method also involves displaying, by the computing device, the probability of acceptance as a probabilistic prediction to the user.

In some embodiments, the applicant is a prospective college student and the institution is a college or university.

In some embodiments, the quantitative or qualitative data collected from the applicant includes class rank, grade point average, number of advanced placement classes completed, scholastic achievement test reading score, scholastic achievement test math score, and/or scholastic achievement test writing score.

In some embodiments, the quantitative or qualitative data collected from the applicant includes information about the applicant's participation in sports.

In some embodiments, the quantitative or qualitative data collected from the applicant includes an applicant assessed rating of the applicant's extracurricular activities, admissions essay, admissions interview, strength of recommendations.

In some embodiments, the quantitative or qualitative data collected from the applicant includes an applicant rating of the applicant's custom chosen parameter.

In some embodiments, the quantitative or qualitative data collected from the applicant includes an applicant's intended major and need for financial aid.

In some embodiments, the method also involves presenting, by the computing device, a probability of acceptance for a predetermined list of colleges or universities selected by the user

In some embodiments, the method also involves presenting, by the computing device, a probability of acceptance for a list of colleges or universities determined based on the probability of acceptance

In some embodiments, the method also involves presenting, by the computing device, a probability of acceptance for a list of colleges or universities sorted by the amount of financial aid offered thereby.

In another aspect, the invention involves a system for generating a probabilistic prediction of an applicant's acceptance by a selective institution.

The system includes a database that stores an institutional predictive model for the selective institution. The institutional predictive model can include statistical quantitative data associated with previous applicants accepted by the institution, statistical converted qualitative data associated with previous applicants accepted by the institution, statistical quantitative data associated with previous applicants rejected by the institution, and statistical converted qualitative data associated with previous applicants rejected by the institution. The system also includes an applicant computing device that collects quantitative or qualitative data from the applicant and a predictive server connected to the database and connected to the applicant computing device. The predictive server compares any quantitative data from the applicant with statistical quantitative data associated with previous applicants accepted by the institution, compares any quantitative data from the applicant with statistical converted qualitative data associated with previous applicants accepted by the institution, compares any quantitative data from the applicant with statistical quantitative data associated with previous applicants rejected by the institution, and compares any quantitative data from the applicant with statistical converted qualitative data associated with previous applicants rejected by the institution. The predictive server also generates a probability of acceptance based on the comparisons and presents the probability of acceptance as the probabilistic prediction to the user. The system also includes a display device that presents the generated probability of acceptance to the user.

The technology comprises a method of generating a probabilistic prediction of an institution accepting an applicant. For example, when generating a college or university's probability of accepting a prospective student, the prediction server uses the applicant's standardized test scores and grade point average (GPA), as well as non-tangible factors, including but not limited to: admission interview evaluation, admissions essay evaluation, strength of secondary recommendations, extracurricular activities, honors, school, local, state, and national awards, publications, civic and charitable works, and entrepreneurship and business experience.

Non-tangible metrics (“intangibles”) can be either self-assessed by the applicant, or assessed by a panel of experts. In some embodiments, the applicant is given standards and examples on how to measure each non-tangible metric. In some embodiments, the applicant also has the option to request a panel of experts, or a panel of peers, to assess the strength of her intangibles. In some embodiments, the assessment will assign a weighted score. For example, an applicant's interview can be qualitatively evaluated on a scale of “poor”, “average”, “good”, or “outstanding”. The predictive server can assign numerical values to each of the assessments (e.g., “outstanding”=90; “good”=70, “average=“50”, etc.) and use the assigned numerical values when evaluating the applicant against an institution's predictive admission model. Similarly, the predictive server can add a numerical value for each award that the applicant received, which may alter the applicant's overall probabilistic prediction of acceptance by institutions. The qualitative (and weighted) data can be added to the applicant's quantitative data.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a diagram of a probabilistic prediction system according to an illustrative embodiment of the invention.

FIG. 2 is a flow chart illustrating a method for probabilistically predicting an applicant's acceptance, according to an illustrative embodiment of the invention.

FIG. 3 illustrates an exemplary input screen for an applicant, according to an illustrative embodiment of the invention.

FIG. 4 illustrates a probabilistic prediction page for a list of institutions, according to an illustrative embodiment of the invention.

### DETAILED DESCRIPTION

FIG. 1 illustrates an exemplary probabilistic prediction system 100, which includes an applicant device 101, a web server 103, a network 107, a predictive server 111, an applicant predictive database (APDB) 113, an institutional server 121, and institutional database 123. The applicant device 101 includes a web browser 102 that connects to the web server 103. The applicant device 101 is in communication with the web server 103, while the predictive server 111 is in communication with the APDB 113. It is apparent to one of ordinary skill in the art that the applicant device 101, the predictive server 111 and the APDB 113 can all be on one computing device, two computing devices, or any combination and/or configuration of computing devices.

Applicant device 101 can be a computing device with a processor and memory that can interact with a website through its web browser 102. For example, the applicant device 101 can include desktop computers, laptop computer, tablet computers, and/or mobile phones connected to the network 107. A user of the applicant device 101 can use the applicant device 101 to connect to the website provided by the web server 103 and can input her metrics to receive a probabilistic prediction generated by the predictive server 111. Web browser 102 can be software used by the applicant device 101 to connect to other devices through the network 107. In some embodiments, the applicant device 101 is connected to the web server 103 before connecting to the network 107. In some embodiments, the web server 103 is connected to the applicant device 101 through the network 107.

Network 107 can be, for example, a packet-switching network that is able to forward packets to other devices based on information included in the packet. The network 107 can provide, for example, phone and/or Internet service to various devices like the applicant device 101 in communication with the network 107. Web server 103 can be, for example, a single web server with a processor and memory. In some embodiments, the web server 103 is a plurality of web servers configured to provide web services to an applicant device 101.

The predictive server 111 can be, for example, a single web server with a processor and memory. In some embodiments, the predictive server 111 can include multiple web servers connected directly or through the network 107. In some embodiments, the predictive server 111 can retrieve data, such as user profiles and institution predictive models stored in APDB 113 to generate its probabilistic prediction. The predictive server 111 can also store updated user profiles and institution probabilistic models in APDB 113. In some embodiments, the predictive server 111 can retrieve institution statistics, such as mean GPA and standardized test scores, etc. from an institutional database 123 via institutional server 121 when generating the institution probabilistic model.

The probabilistic model can be based on a group method of data handling (GMDH), a naïve Bayesian classifier, a k-nearest neighbor algorithm, a majority classifier, a support vector machine, a random forest, gradient boosting, classification and regression trees, multivariate adaptive regression splines, or artificial neural networks.

In some embodiments, the predictive server 111 can retrieve institution statistics from other sources, such as public domain web pages. In some embodiments, the predictive server 111 can also provide other software to applicant device 101 and the institution server 121. For example, the predictive server 111 can provide application filing software to the applicant device 101, or data uploading software to the institutional server 121.

The APDB 113 can be a database in communication with the predictive server 111 that can provide applicant profiles and institution predictive models to the predictive server 111. In some embodiments, the APDB 113 is in communication with the predictive server 111 through a direct connection. In some embodiments, the APDB 113 is in communication with the predictive server 111 through the network 107. In some embodiments, the APDB 113 stores the applicant profiles generated by the applicants through applicant device 101. In some embodiments, the APDB 113 can store applicant and acceptance statistics received by the predictive server 111. In some embodiments, the APDB 113 can accumulate and store institution acceptance data received by the predictive server 111 from a plurality of applicant devices 101 over time. In some embodiments, the APDB 113 can store statistical models formed by the predictive server 111. The predictive server 111 can access the APDB 113 when forming probabilistic prediction values, updating institution predictive models, and accumulating user profile data. The predictive server 111 can use information stored in the APDB 113 with other information, such as third-party acceptance data retrieved from other sources when forming or modifying probabilistic predictions and/or institution predictive models.

Institutional database (DB) 123 can be one or more databases in communication with the predictive server 111 through the network 107 and institutional server 121. Institutional server 123 can be, for example, a single web server with a processor and memory that is controlled by a party other than the applicant or the controller of the predictive server. Institutional server 123 can accumulate and store applicant data and acceptance statistics, which the predictive server 111 can access when forming and modifying its probabilistic predictions and/or institution predictive models. In some embodiments, the data stored in the institutional database 123 is static. In some embodiments, the data stored in the institutional database 123 is consistently updated by the institution.

Both the APDB 113 and the Institutional DB 123 can contain applicant statistics, student body statistics and accepted student statistics. This data can include, for example, median SAT scores and/or high school GPA of accepted students, median high school GPA of the student body, financial aid data (e.g., average loan amount, average grant award, etc.), academic reputation (e.g., national ranking, funding awarded, publication data) of institutional departments, campus location, and/or conditional admission data. In some embodiments, such data can also be retrieved from public domain sources.

In some embodiments, the predictive server 111 can retrieve quantitative metrics provided by the applicant through applicant device 101 and compare them to the institution's statistical data. For example, the predictive server 111 can retrieve an institution's published median admission SAT score 1800. In such instances, the predictive server 111 can compare a user's combined SAT score to the institutional score of 1800. In some embodiments, the predictive server 111 can track the results of admissions decisions for applicants with various quantitative scores. For example, the predictive server 111 can track and the APDB 113 can store data indicating an unusually-high number of applicants being accepted with combined SAT scores two or three standard deviations lower than the median combined SAT score provided by the university. The prediction server 111 can accordingly alter its probabilistic prediction to indicate a higher probability of an applicant with a lower test score being accepted by the institution. In some embodiments, the predictive server 111 can alter the weight given to the combine SAT score its institution predictive model for that institution. Similarly, in some embodiments, when the predictive server 111 identifies a pattern where an institution accepts applicants with high math SAT scores over those with equally high verbal or reading SAT scores given similar combined SAT scores, the predictive server can alter its institution predictive model to more heavily weigh specifically the math section of the SAT score.

Predictive server 111 can use qualitative data from the applicant to make probabilistic predictions. Predictive server 111 can retrieve ratings for qualitative metrics and assign numerical values to them and can proceed to compare the numerical values with associated values in the institution predictive model. In some embodiments, the predictive server 111 can use such values to generate the probabilistic prediction. In some embodiments, the predictive server 111 can use the qualitative metrics to find patterns in the acceptance practice of an institution. For example, if a university has consistently demonstrated that it favors one intangible factor (e.g., personal interview rating) over another quantitative metric (e.g., number of AP classes taken) or qualitative metric (e.g., applicant is a varsity sports team captain), the predictive server 111 will modify the weight of such metrics in the institutional predictive model and accordingly modify its probabilistic prediction based on the change in the predictive model.

FIG. 2 describes a method of probabilistic prediction of an applicant's acceptance according to an illustrative embodiment of the invention.

The method includes collecting data from an applicant (Step 202). For example, as shown above in FIG. 1, the data can be collected by applicant computing device 101. The predictive server 111 can retrieve the collected data from the applicant computing device 101, via web server 103 and network 107. In various embodiments, the applicant is an applicant to college and/or university. In various embodiments, the data is quantitative and/or qualitative data. Quantitative data can include an applicant class rank, GPA, number of advanced placement classes, standardized test scores, or any combination thereof. Qualitative data can include applicant self-assessments of the following: extracurricular activity participation, essay quality, interview performance, letters of recommendation, or any combination thereof. Qualitative data can also include intended major, need for financial aid, and/or additional factors (e.g., participation in the Intel talent search). In some embodiments, the predictive server 111 can retrieve institutional statistical data from institutional database 123 via institutional server 121.

The method also includes comparing data from the applicant with data of previously accepted applicants (Step 204). In some embodiments, the predictive server 111 compares the collected applicant data with institutional statistical data regarding previously accepted applicants. In some embodiments, the institutional statistical data is quantitative. In some embodiments, the institutional statistical data is qualitative data that has been converted into statistical form (e.g., an applicant's qualitative performance on an essay may be characterized as outstanding, good, average, or poor).

The method also includes comparing data from the applicant with data of previously rejected applicants (Step 206). In some embodiments, the predictive server 111 compares the collected applicant data with institutional statistical data regarding previously rejected applicants. In some embodiments, the institutional statistical data is quantitative. In some embodiments, the institutional statistical data is qualitative data that has been converted into statistical form.

The method also includes generating a probability of an applicant's acceptance based on the comparisons (Step 208). In some embodiments, the predictive server 111 generates a probability of acceptance based on an institutional predictive model stored in APDB 113 in combination with the comparisons between the applicant data and the data associated with previous applicants.

The method also includes displaying a probability of acceptance to a user (Step 210). In some embodiments, the predictive server 111 transmits a probability of acceptance to the applicant computing device 101 via network 107 and web server 103. The applicant computing device 101 can display the received probability of acceptance to a user.

FIG. 3 illustrates an exemplary input screen 300 for an applicant. The input screen 300 includes quantitative inputs 304 and qualitative inputs 308. The quantitative inputs 304 include inputs for class rank, GPA, number of AP classes, and SAT scores. The qualitative inputs 308 include participation in sports, applicant performance in extracurricular activities, admission essay quality, admission interview performance, intended major, and/or financial aid requirements. In some embodiments, the qualitative inputs 308 include inputs for additional factors such as participation in the Intel talent search, Google science, science Olympiad, and/or national orchestra.

In some embodiments, the additional factors include applicant published books, articles, and/or op-eds. In some embodiments, the additional factors include whether or not the applicant is an Olympic athlete or sports team captain. In some embodiments, the additional factors include whether or not the applicant has established a tech start-up or non-governmental organization.

The applicant can input one or more metrics associated with metrics used by institutions when making acceptance decisions. In some embodiments, the input screen can also include other predictive metrics that are not actually used by the institution when making admissions decisions. For example, the input screen 300 can allow the applicant to indicate whether she will need financial aid. However, the institution for which she requests a probabilistic prediction may make “need-blind” admissions and therefore not use that metric in their determinations.

In some embodiments, the predictive server 111 does not use a metric when an institution does not use the metric in their acceptance decisions. In some embodiments, the prediction server will track metrics not used by an institution in acceptance decisions and will include the metric when making a probabilistic prediction.

In some embodiments, the prediction server can track the applicant's metrics by saving them in an applicant profile. In such embodiments, the applicant can add, modify, or delete the metrics at later times. In some embodiments, the applicant can also indicate whether she has been accepted or rejected to specific universities. The predictive server can collect the actual institution acceptance decisions from the applicant's profile and adjust the institution's predictive admission model. This can allow the predictive server to make more accurate probabilistic predictions.

For example, an applicant prospective student can include in their profile: country of origin, age, current high school, high school grade point average (GPA), number of advanced placement exams taken (and passed), standardized examination scores (SAT I, SAT II, ACT, AP, IB, etc.), English language test scores, and/or qualitative metrics evaluations, including honors, awards, and/or publications. The profile can also include a list of colleges to which the applicant has applied, colleges that have accepted the applicant, colleges that have rejected the applicant, as well as the college the applicant has decided to attend. When the applicant inputs, modifies, or updates such data, the predictive server can adjust data associated with the applicable colleges based on the data in the user profile. As data collected from the institution, the applicant, or the public domain alone may be inaccurate or fraudulent, the predictive server can use data from all such sources when making the institution predictive model, which increases the accuracy of its probabilistic predictions. Further, the predictive server can offer insights into the types of applicants accepted beyond the metrics actually used by the institution.

In some embodiments, the applicant can pick specific institutions for probabilistic prediction. In some embodiments, the applicant can input preferences and allow the predictive server to provide a list of recommended institutions based on such preferences. In some embodiments, the predictive server can use a ranking formula based on applicant preferences to generate the recommendation list. In some embodiments, the recommendation list of institutions can also include a minimal probabilistic threshold. For example, the predictive server can generate a list of recommended universities on the East Coast with tuition under $40,000 where the applicant has a higher than 75% chance of acceptance. In some embodiments, the list of recommended institutions can also present institution facts and insights, such as useful university-specific tips to applicants based on their preferences and on the input values.

In some embodiments, the applicant can request predictions for a list of institutions specified by the applicant. In some embodiments, the predictive server 111 can use a plurality of institutional predictive models and institutional data stored in the APDB 113 to provide a recommended list of institutions based on the probabilistic prediction value and the preferences of the user.

For example, the applicant in FIG. 3 can, in addition to entering qualitative and quantitative metrics, input preferences like type of major or whether they would require financial aid options. Predictive server 111 can then recommend a list of institutions based on the user's preferences. In some embodiments, the predictive server 111 provides a list of recommendations based on the probabilistic prediction value (e.g., P(acceptance)=0.8) and retrieved user preferences. For example, if the user indicates that financial aid is very important, the predictive server 111 can rank institutions with a high “financial aid per student” ratio higher in the generated recommendation list. If a user intends to major in mathematics, the predictive server 111 can list institutions associated with strong math departments higher in the recommendation list, as an institution's departmental academic reputation can be part of its profile.

FIG. 4 illustrates a probabilistic predictions page 400 for a list of institutions to display to an applicant, according to an illustrative embodiment of the invention. The probabilistic predictions page 400 can include a list 410 of institutions. The list of institutions 410 can include an institutional name 415 and 425, an institutional logo 412 and 422, the total enrollment and yearly tuition 416 and 426, an applicant specific institutional classification 417 and 427 (e.g., dream school, realistic school, and/or safety school), an estimate made by predictive server 111 of the applicant's probability of acceptance 414, 424, and/or institution specific tips and insights 419 and 429.

In some embodiments, the list of institutions is selected by the applicant. In some embodiments, the list of institutions is generated by the predictive server 111. The list of institutions 410 can include three dream schools, six realistic schools, and three safety schools. Dream schools can be selective schools that the applicant should strive for. Realistic schools can be schools where the predictive server 111 has determined that the applicant has a relatively high probability of acceptance (e.g., greater than 50%). Safety schools can be schools where the predictive server 111 has determined that the applicant has a very high probability of acceptance (e.g., greater than 90%).

In some embodiments, the institution specific tips and insights 419 and 429 include whether the institution is located in a city with a relatively low crime rate, or has a relatively low tuition. To further an applicant's understanding of the prediction, each of the resulting institutions in the list of institutions 410 can be provided with data from its institutional profile, such as, for example, admission, financial aid, campus life data, reviews, and/or tips for the prospective applicant. In some embodiments, the predictive server 111 can rank the data and present specific items based on rank. Predictive server 111 can produce the rankings of information based, for example, on the probabilistic prediction and user preferences. For example, if a user indicated that she has a strong need for financial aid, financial aid information will be more likely to be presented by the predictive server 111. Similarly, if the user has 1600 combined SAT score and the university's median combined SAT score is 1700, the predictive server can indicate in the presented data that she has a combined SAT score that is 100 points lower than the institution's median combined SAT score. In addition, if a user indicates that she wants to major in an engineering discipline, the predictive server 111 can retrieve study tips for the math section of the SAT or science sections of the SAT II.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., plasma display or LCD (liquid crystal display), for displaying information to the user, and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, and/or other communication protocols.

Devices of the computing system can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a World Wide Web browser (e.g., Microsoft® Internet Explorer® available from Microsoft Corporation, Mozilla® Firefox available from Mozilla Corporation). Mobile computing device include, for example, a Blackberry®. IP phones include, for example, a Cisco® Unified IP Phone 7985G available from Cisco Systems, Inc, and/or a Cisco® Unified Wireless Phone 7920 available from Cisco Systems, Inc.

While the technology has been particularly shown and described with reference to specific illustrative embodiments, it should be understood that various changes in form and detail may be made without departing from the spirit and scope of the technology.

What is claimed is:

1. A computerized-method for generating a probabilistic prediction of an applicant's acceptance by a selective institution, the method comprising:
collecting, by a computing device, quantitative or qualitative data from the applicant;
comparing, by the computing device, data from the applicant with statistical quantitative data associated with previous applicants accepted by the institution;
comparing, by the computing device, data from the applicant with statistical converted qualitative data associated with previous applicants accepted by the institution;
comparing, by the computing device, data from the applicant with statistical quantitative data associated with previous applicants rejected by the institution;
comparing, by the computing device, quantitative data from the applicant with statistical converted qualitative data associated with previous applicants rejected by the institution;
generating, by the computing device, a probability of acceptance based on the comparisons; and
displaying, by the computing device, the probability of acceptance as a probabilistic prediction to the user.

2. The method of claim 1, wherein the applicant is a prospective college student and the institution is a college or university.

3. The method of claim 2, wherein the quantitative or qualitative data collected from the applicant includes class rank, grade point average, number of advanced placement classes completed, scholastic achievement test reading score, scholastic achievement test math score, scholastic achievement test writing score.

4. The method of claim 2, wherein the quantitative or qualitative data collected from the applicant includes information about the applicant's participation in sports.

5. The method of claim 2, wherein the quantitative or qualitative data collected from the applicant includes an applicant assessed rating of the applicant's extracurricular activities, admissions essay, admissions interview, strength of recommendations.

6. The method of claim 2, wherein the quantitative or qualitative data collected from the applicant includes an applicant rating of the applicant's custom chosen parameter.

7. The method of claim 2, wherein the quantitative or qualitative data collected from the applicant includes an applicant's intended major and need for financial aid.

8. The method of claim 2, further comprising presenting, by the computing device, a probability of acceptance for a predetermined list of colleges or universities selected by the user.

9. The method of claim 2, further comprising presenting, by the computing device, a probability of acceptance for a list of colleges or universities determined based on the probability of acceptance.

10. The method of claim 2, further comprising presenting, by the computing device, a probability of acceptance for a list of colleges or universities sorted by the amount of financial aid offered thereby.

11. A system for generating a probabilistic prediction of an applicant's acceptance by a selective institution comprising:
a database that stores an institutional predictive model for the selective institution, the institutional predictive model comprising:
statistical quantitative data associated with previous applicants accepted by the institution;
statistical converted qualitative data associated with previous applicants accepted by the institution;
statistical quantitative data associated with previous applicants rejected by the institution; and
statistical converted qualitative data associated with previous applicants rejected by the institution;
an applicant computing device that collects quantitative or qualitative data from the applicant; and
a predictive server connected to the database and connected to the applicant computing device, wherein the predictive server:
compares any quantitative data from the applicant with statistical quantitative data associated with previous applicants accepted by the institution;
compares any quantitative data from the applicant with statistical converted qualitative data associated with previous applicants accepted by the institution;
compares any quantitative data from the applicant with statistical quantitative data associated with previous applicants rejected by the institution; and
compares any quantitative data from the applicant with statistical converted qualitative data associated with previous applicants rejected by the institution;
generates a probability of acceptance based on the comparisons; and
a display device for presenting the probability of acceptance as the probabilistic prediction to the user.
